(19) United States
(12) Patent Application Publication
(10) Pub. No.: US 2006/0256748 A1
(43) Pub. Date: Nov. 16, 2006

(54) System and method for interworking between IMS network and H.323 network

(75) Inventors: Joon-Ho Jung, Suwon-si (KR); Deug-Ku Chang, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/429,976

(22) Filed: May 9, 2006

(30) Foreign Application Priority Data
May 10, 2005 (KR) 10-2005-0038861

(51) Int. Cl. H04Q 7/00; H04L 12/66; H04L 12/56

(52) U.S. Cl. 370/328; 370/401; 370/352

(57) ABSTRACT

A system and method are provided for interworking between an Internet Protocol (IP) Multimedia Core Network Subsystem (IMS) network that provides an IP multimedia service to at least one first terminal, and an H.323 network that provides a packet switched multimedia service to at least one second terminal. In the system and method, upon receiving an invite message from the first terminal, a Call Session Control Function (CSCF) determines whether the second terminal is a terminal serviceable via the H.323 network through a query with a Domain Name Server (DNS). If the second terminal is a terminal serviceable via the H.323 network, the CSCF transmits an invite message including codec information of the first terminal to an interworking function (IWF), and sends a request for a transcoding service to a transcoding unit upon receiving from the IWF a response message including a codec list supportable by the H.323 network. Upon receiving an invite message including transcoding information from the transcoding unit via the CSCF, the IWF translates the invite message into a call setup message and transmits the call setup message to the H.323 network. Upon receiving the call setup message from the IWF, a gatekeeper sets up a call to the IMS network.

### CROSS-REFERENCE TO RELATED APPLICATIONS

This application claims the benefit under 35 U.S.C. §119(a) of Korean Patent Application No. 10-2005-0038861 entitled “System and Method for Interworking between IMS Network and H.323 Network” filed in the Korean Intellectual Property Office on May 10, 2005, the entire contents of which are hereby incorporated by reference.

### BACKGROUND OF THE INVENTION

1. Field of the Invention

The present invention relates generally to a system and method for interworking between an IMS network and an H.323 network. In particular, the present invention relates to a system and method for interworking between networks having different codecs.

2. Description of the Related Art

In general, mobile communication systems providing a circuit switched voice service are classified, according to their communication methods, as a Frequency Division Multiple Access (FDMA) system that divides a predetermined frequency band into a plurality of channels and individually allocates the frequency channels to users, a (Time Division Multiple Access (TDMA) system in which one frequency channel is time-shared by a plurality of users, and a Code Division Multiple Access (CDMA) system in which multiple subscribers use the same frequency channel in the same time interval with unique codes allocated thereto.

With the rapid development of the CDMA mobile communication system and Internet technology, and to meet the increasing users' demands for various services, recent mobile communication services have developed to a level of providing not only existing voice call services, but also high-speed packet data services that allow subscribers to enjoy E-mail and still images, and also allow subscribers to transmit high-capacity digital data with mobile terminals. That is, the mobile communication system is now evolving from the circuit switched (CS) domain into the packet switched (PS) domain.

Accordingly, a core network (CN) that provides multimedia service over the Internet is changing from the existing circuit switched CN, to the packet switched CN, thereby evolving into an IP based CN. A communication system that provides an IP Multimedia service (IM service) to subscribers via the IP based CN is called an IP Multimedia Core Network Subsystem (IMS), and in the 3^{rd} Generation Partnership Project (3GPP)/3^{rd} Generation Partnership Project 2 (3GPP2), various research is being conducted to smoothly provide ALL IP service via the IMS.

The IMS is an aggregation of signaling bearers associated with network elements, and should be able to approach the web-based technology for voice, video, message data and wireless subscribers. In addition, because the IMS provides various types of packet data services based on the IP transport protocol, IMS users can exchange with other users the multimedia contents such as pictures, video clips and sound clips through session based messages.

FIG. 1 is a diagram illustrating a conventional interworking configuration between IMS networks, i.e., an interworking configuration between an A IMS network and a B IMS network. With reference to FIG. 1, a description will now be made of the conventional interworking configuration between IMS networks.

An IMS system for providing IP Multimedia (IM) service, as illustrated in FIG. 1, comprises a Call Session Control Function (CSCF) 110 for performing registration and multimedia call processing functions using a Session Initiation Protocol (SIP), and a Home Subscriber Server (HSS) 120 for integratedly performing mobility management and authentication of IM service users in a Home Location Register (HLR) of the conventional mobile communication network. The CSCF 110 is connected to a transcoding unit 130 that provides transcoding service. The transcoding unit 130 comprises an Application Server (AS) 131 that provides transcoding service, and a Multimedia Resource Function (MRF) (Controller+Processor) 133.

The HSS 120 (and HSS 121) store subscriber information and a service profile, and the CSCF 110 represents a Serving CSCF (S-CSCF), and actually performs call session and service setup in response to call setup and service setup requests.

The S-CSCF 110 can exist as a separate network element, or can coexist with a Proxy Call Session Control Function (P-CSCF) and an Interrogating Call Session Control Function (I-CSCF) defined in the IMS. The P-CSCF has a function for delivering registration and originating/terminating call requests from a visit network of a user to the home network, and the I-CSCF has a function for selecting an S-CSCF appropriate to a call request of the user among a plurality of S-CSCFs, and also has a function for preventing configuration information of the S-CSCF located in the home network from being shown to other networks for security purposes.

The AS 131, which provides transcoding service, determines which service it should provide to an originating subscriber, and provides the corresponding service to the subscriber. The transcoding occurs when an originating terminal (or calling terminal) and a terminating terminal (or called terminal) attempt a call using different codecs.

The MRF 133, equipment for performing transcoding between different codecs, performs transcoding in response to a request of the AS 131. Further, the MRF 133 has a bearer connection between an originating terminal 100 and a terminating terminal 101, and performs transcoding between the two terminals.

The originating terminal 100 transmits an Invite message to the originating S-CSCF 110 in step 101. The originating S-CSCF 110, after receiving the Invite message from the originating terminal 100, determines in step 102 with which AS it will connect through an initial Filter Criteria (iFC) transmitted from the HSS 120, and transmits an Invite message to the determined AS 131. The operation occurring in step 102 is defined as an operation for performing service triggering in the originating S-CSCF 110. In steps 103 and 104, the originating S-CSCF 110 transmits an Invite message to the terminating terminal 101 via a terminating S-CSCF 111. Then, in steps 105 to 107, the terminating terminal 101 transmits a 606 Not Acceptable message indicating unacceptability of codec information of the originating terminal to the AS 131 via the terminating S-CSCF 111 and the originating S-CSCF 110. In step 108, an Invite message, a 200 OK message and an ACK message are exchanged between the AS 131 and the MRF 133, and the AS 131 and the MRF 133 are connected through the originating S-CSCF 110. Thereafter, the AS 131 transmits an Invite message to the terminating terminal 101, and performs a general procedure in which a 183 Session Progress message is transmitted.

In the IMS network, transcoding occurs when the originating (calling) terminal 100 and the terminating (called) terminal 101 are different from each other in their codec. Upon receiving a first Invite message, the terminating terminal 101 transmits the 606 Not Acceptable message when it cannot support the codec provided by the originating terminal 100. The 606 Not Acceptable message is forwarded to the AS 131 that takes charge of transcoding service, via the terminating S-CSCF 111 and the originating S-CSCF 110, and the AS 131 provides transcoding using the MRF 133. Because the current IMS network has a configuration using iFC, the S-CSCF 110 receiving the first Invite message should transmit an Invite message to the AS 131 when there is a need for the transcoding service. Thereafter, the call processing for transcoding is managed by the AS 131.

A description will now be made of a protocol supporting a video conference. For example, H.323 is an international standard for the protocol supporting the video conference. In order to perform the video conference supporting both video and audio, an H.323 network first exchanges necessary information, and then obtains a channel for transmitting data. An operation performed in an H.323 terminal to make a conversation with the other party is as follows. The H.323 terminal first sets up a call to the other party. The H.323 terminal, after successfully setting up the call, establishes a route for transmitting compatible data with an H.245 protocol, and exchanges audio/video data in real time using Real Time Protocol (RTP)/Real Time Control Protocol (RTCP).

In another example, 3GPP TS 29.162 “Interworking between the IM CN subsystem and IP network”, presents an interworking scheme between an IMS network and an IP network. However, this standard proposes only the interworking configuration between 3GPP profile-based SIP and IETF standard SIP, and presents no interworking scheme between the IMS network and the H.323 network.

In interworking between an SIP-based IMS network and an H.323 network, transcoding occurs because of inconsistency in codecs between the two networks. For example, an IMS codec includes G.711, G.723, G.729, adaptive Multi Rate (AMR) Codec), and Enhanced Variable Rate Codec (EVRC) codecs for audio, and includes H.261, H.263, and Moving Picture Experts Group-4 (MPEG4) codecs for video. An H.323 codec includes a basic G711 codec, and additional G.722, G.723.1, G.728, and G.729 codecs for audio, and includes H.261, and H.263 codecs for video. Because the current IMS network provides an iFC-based triggering mechanism, the call processing for transcoding should be performed in the AS 131 and not in the S-CSCF 110. In the IMS network, the terminating terminal 101 should transmit the 606 Not Acceptable message indicating unacceptability of the codec information of the originating terminal 100 in order to perform the service. This configuration may generate an additional call path on the assumption that there is a need for transcoding in most call setups in interworking with the H.323 network.

Accordingly, a need exists for a system and method for effectively and efficiently interworking between an IMS network and an H.323 network.

### SUMMARY OF THE INVENTION

It is, therefore, an object of embodiments of the present invention to substantially solve the above and other problems, and to provide a system and method for interworking between an IMS network and an H.323 network.

It is another object of embodiments of the present invention to provide a system and method for providing transcoding service necessary for interworking between an IMS network and an H.323 network.

According to one aspect of embodiments of the present invention, a system is provided for interworking between an Internet Protocol (IP) Multimedia Core Network Subsystem (IMS) network that provides an IP multimedia service to at least one first terminal, and an H.323 network that provides a packet switched multimedia service to at least one second terminal. The system comprises a Call Session Control Function (CSCF) for, upon receiving an invite message from the first terminal, transmitting an invite message comprising codec information of the first terminal to an interworking function (IWF) if the second terminal is determined to be a terminal serviceable via the H.323 network through a query with a Domain Name Server (DNS) that provides subscriber information, and sending a request for a transcoding service to a transcoding unit upon receiving from the IWF a response message including a codec list supportable in the H.323 network. The system further comprises the IWF for, upon receiving an invite message comprising codec information of the first terminal from the CSCF, transmitting to the CSCF a codec list supportable in the H.323 network with which it can interwork, and upon receiving from the CSCF an invite message comprising codec information provided by the transcoding unit, translating the received invite message into a call setup message and transmitting the call setup message to the H.323 network. The system still further comprises a gatekeeper for setting up a call to the IMS network upon receiving the call setup message from the CSCF.

According to another aspect of embodiments of the present invention, a method is provided for interworking between an Internet Protocol (IP) Multimedia Core Network Subsystem (IMS) network that provides an IP multimedia service to at least one first terminal, and an H.323 network that provides a packet switched multimedia service to at least one second terminal. The method comprises the steps of, upon receiving an invite message from the first terminal, determining by a Call Session Control Function (CSCF) whether the second terminal is a terminal serviceable via the H.323 network, through a query with a Domain Name Server (DNS) and if the second terminal is a terminal serviceable via the H.323 network, transmitting, by the CSCF, an invite message comprising codec information of the first terminal to an interworking function (IWF), and sending a request for a transcoding service to a transcoding unit upon receiving from the IWF a response message comprising a codec list supportable by the H.323 network. The method further comprises the steps of, upon receiving an invite message comprising transcoding information from the transcoding unit via the CSCF, translating, by the IWF, the invite message into a call setup message and transmitting the call setup message to the H.323 network and upon receiving the call setup message from the IWF, setting up, by a gatekeeper, a call to the IMS network.

According to another aspect of embodiments of the present invention, an apparatus is provided for interworking between an Internet Protocol (IP) Multimedia Core Network Subsystem (IMS) network that provides an IP multimedia service to at least one first terminal, and an H.323 network that provides a packet switched multimedia service to at least one second terminal. The apparatus comprises a message translator for translating a message transmitted between the IMS network and the H.323 network, a codec list manager for providing a codec list supportable by the H.323 network to a Call Session Control Function (CSCF) through a response message, for a first invite message in the IMS network, a Registration, Admission, and Status (RAS) for executing a RAS command through a RAS signal processing protocol for interworking with a gatekeeper, and a controller for controlling interworking between the IMS network and the H.323 network.

According to yet another aspect of embodiments of the present invention, a method is provided for interworking between an Internet Protocol (IP) Multimedia Core Network Subsystem (IMS) network that provides an IP multimedia service to at least one first terminal, and an H.323 network that provides a packet switched multimedia service to at least one second terminal. The method comprises the steps of receiving an invite message comprising codec information of the first terminal from a Call Session Control Function (CSCF), determining whether a codec of the first terminal is supportable in the H.323 network and if the codec of the first terminal is unsupportable, transmitting a response message to the CSCF, determining whether there is any invite message comprising transcoding information, received from a transcoding unit and upon receiving an invite message including the transcoding information, translating the invite message into a call setup message and transmitting the call setup message to the H.323 network.

### BRIEF DESCRIPTION OF THE DRAWINGS

The above and other objects, features and advantages of embodiments of the present invention will become more apparent from the following detailed description when taken in conjunction with the accompanying drawings, in which:

FIG. 1 is a diagram illustrating a conventional interworking configuration between IMS networks;

FIG. 2 is a diagram illustrating an exemplary interworking configuration between an IMS network and an H.323 network according to an embodiment of the present invention;

FIG. 3 is a block diagram illustrating a detailed configuration of an exemplary IMS network according to an embodiment of the present invention;

FIGS. 4A and 4B are signaling diagrams illustrating an exemplary interworking method between an IMS network and an H.323 network according to an embodiment of the present invention; and

FIG. 5 is a flowchart illustrating an exemplary control flow of an H.323-IWF during interworking between an IMS network and an H.323 network according to an embodiment of the present invention.

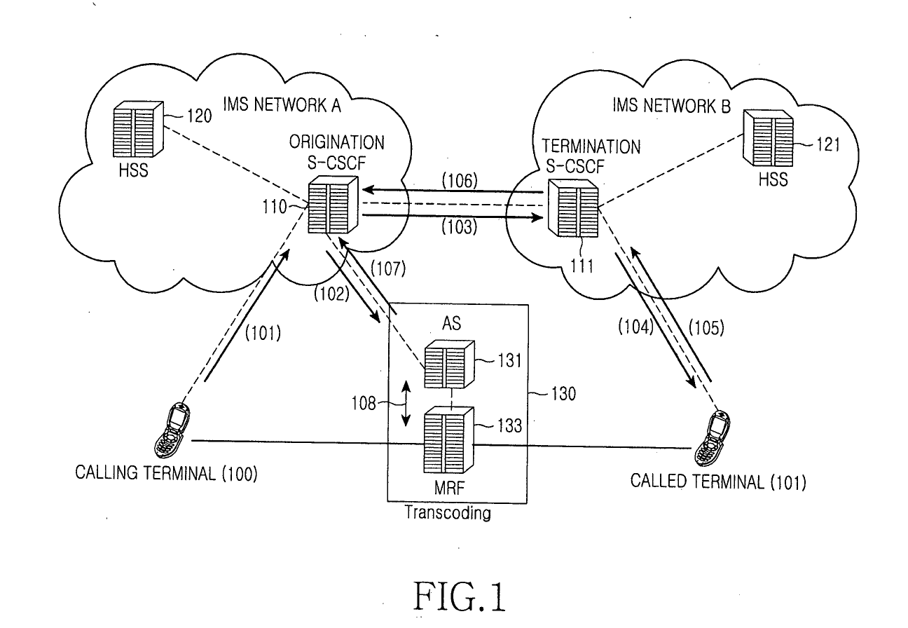

Throughout the drawings, like reference numerals will be understood to refer to like parts, components and structures.

### DETAILED DESCRIPTION OF EXEMPLARY EMBODIMENTS

Exemplary embodiments of the present invention will now be described in detail with reference to the annexed drawings. In the following description, a detailed description of known functions and configurations incorporated herein has been omitted for clarity and conciseness.

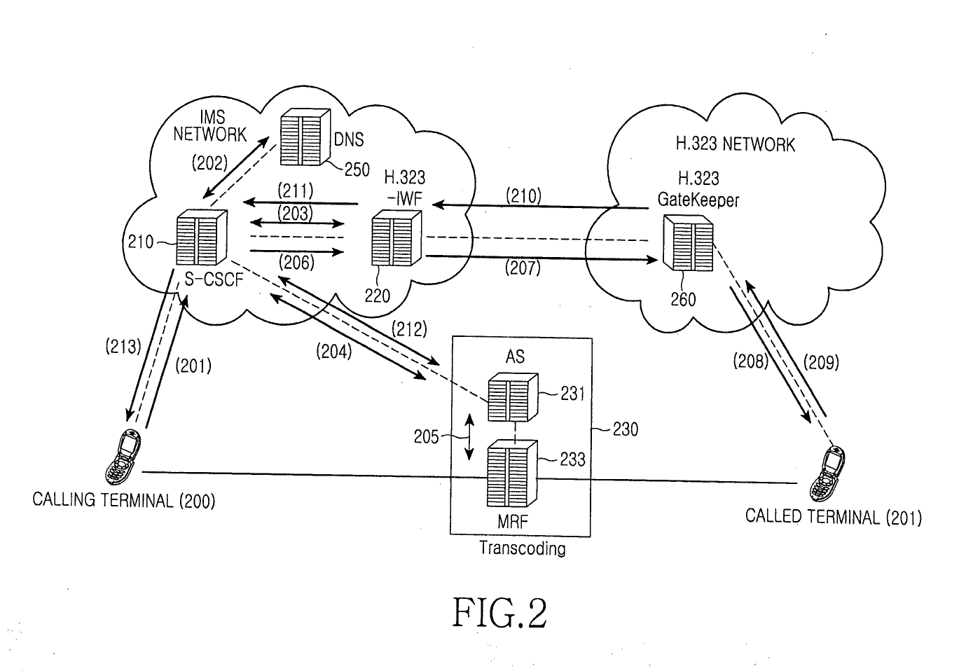

FIG. 2 is a diagram illustrating an exemplary interworking configuration between an IMS network and an H.323 network according to an embodiment of the present invention.

An IMS network, as illustrated in FIG. 2, comprises an S-CSCF 210 serving as a call server, a Domain Name Server (DNS) 250 for handling a query from the S-CSCF 210, and an H.323-Inter-Working Function (H.323-IWF) 220 for providing an interworking function with an H.323 network.

The S-CSCF 210 is connected to a transcoding unit 230 that provides transcoding service. The transcoding unit 230 comprises an AS 231 and an MRF 233 for providing the transcoding function. An originating (calling) terminal 200 is connected to the IMS network.

The H.323 network, as illustrated in FIG. 2, comprises an H.323 gatekeeper 260 for handling interworking with the IMS network. The gatekeeper 260 manages a call of the terminal that performs H.323 communication. A terminating (called) terminal 201 is a terminal supporting an H.323 protocol. Detailed descriptions of other network elements in the exemplary IMS network and the H.323 network that are well known to those skilled in the art are omitted herein for clarity and conciseness.

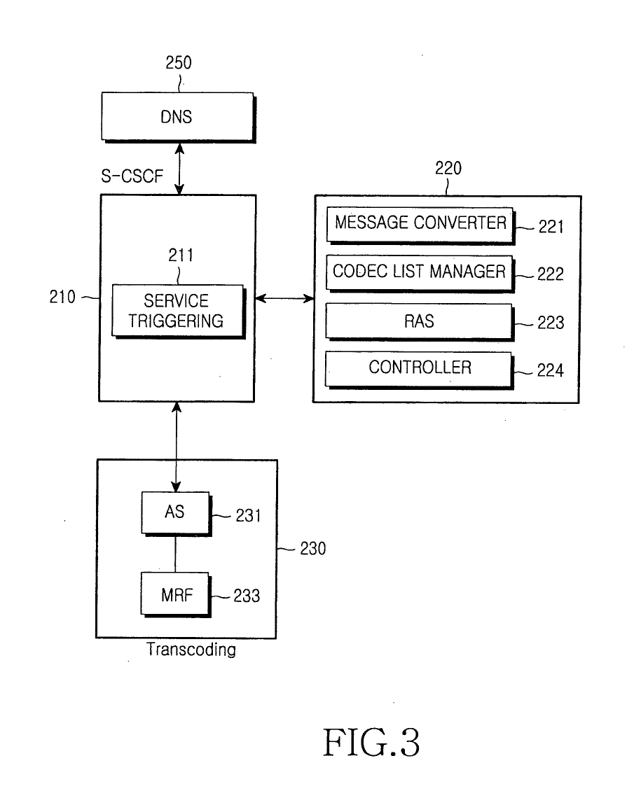

FIG. 3 is a block diagram illustrating a detailed configuration of an exemplary IMS network according to an embodiment of the present invention.

The S-CSCF 210, upon receipt of an Invite message from the originating terminal 200, checks subscriber information of the terminating terminal 201 through query with the DNS 250. If it is determined from the subscriber information that the terminating terminal 201 is a terminal capable of receiving a service via the H.323 network, the S-CSCF 210 transmits an Invite message to the H.323-IWF 220. The S-CSCF 210, as illustrated in FIG. 3, comprises a service triggering unit 211. The service triggering unit 211 performs service triggering in response to a 606 Not Acceptable message transmitted from the H.323-IWF 220. The 606 Not Acceptable message indicates that the terminating terminal 201 does not support an H.323 codec of the originating terminal 200.

The S-CSCF 210, upon receipt of the 606 Not Acceptable message, sends a transcoding request to the AS 231, and if transcoding is performed by the MRF 233, the S-CSCF 210 transmits an Invite message to the H.323-IWF 220 for call setup to the terminating terminal 201.

The S-CSCF 210 should preferably interwork with the H.323-IWF 220 and the AS 231 using a standard interface. Even though the two functions (H.323-IWF 220 and AS 231) exist in the S-CSCF, the S-CSCF 210 should preferably interwork with them using the standard interface.

The DNS 250, upon receipt of any query from the S-CSCF 210, informs the S-CSCF 210 of a type of the terminating terminal 201, and delivers an IP address to the S-CSCF 210.

The AS 231, upon receipt of any transcoding service request from the S-CSCF 210, performs a call process for providing the transcoding service, selects an MRF 233 supporting the transcoding function, and sends a request for the transcoding service to the selected MRF 233. The AS 231, as it performs a basic function for network interworking rather than a particular service, can either exist independent of the S-CSCF 210, or exist in the S-CSCF 210 as an inner service function block. The AS 231, which comprises a service subject for providing the transcoding function, performs a call control function after the S-CSCF 210 performs service triggering for the 606 Not Acceptable message. The AS 231 provides the transcoding service using the transcoding function provided by the MRF 233.

The MRF 233, which comprises equipment for actually performing a transcoding function between different codecs, performs transcoding in response to a request of the AS 231. The MRF 233 has bearer connections for the originating terminal 200 and the terminating terminal 201, and performs transcoding between the two terminals. The MRF 233 transmits a Transcoding Ready Complete message to the AS 231 to indicate that it is ready for the transcoding. The MRF 233 can exist as a separate network element, and should preferably be able to exist in the same network element as the AS 231 supporting the transcoding service.

The H.323-IWF 220 is connected to the S-CSCF 210 with an SIP interface, and connected to the H.323 gatekeeper 260 with an H.323 interface. Because the gatekeeper is a network element that performs interworking of the H.323 network according to the TTA standard, the H.323-IWF 220 also has a partial function of the H.323 gatekeeper 260. The H.323-IWF 220 transmits a 606 Not Acceptable message to the S-CSCF 210 in response to a first Invite message transmitted to the H.323 network, enabling fast transcoding service. The H.323-IWF 220, as illustrated in FIG. 3, comprises a message translator or converter 221, a codec list manager 222, a Registration, Admission, and Status (RAS) 223, and a controller 224.

The message translator 221 provides the IMS network with a translation function for the message transmitted to the H.323 network. For example, to set up a call to the H.323 network, the message translator 221 translates an Invite message transmitted from the S-CSCF 210 into a call setup message, and translates an Alerting message transmitted from the H.323 gatekeeper 260 into a 183 Session Progress message.

The codec list manager 222 provides the S-CSCF 210 with a codec list supportable by the H.323 network for the first Invite message transmitted in the IMS network.

The RAS 223 carries out a RAS command through a RAS signal processing protocol for interworking with the H.323 gatekeeper 260. The RAS signal processing protocol performs registration, connection authentication, bandwidth change, state report and connection release procedures between the H.323-IWF 220 and the H.323 gatekeeper 260.

The controller 224 performs the overall control operation so that the H.323-IWF 220 can allow the IMS network and the H.323 network to interwork with each other according to an embodiment of the present invention. The H.323-IWF 220 can exist as one independent network element, or can exist as the same network element as the S-CSCF function block.

A description will now be made of an exemplary interworking method between the IMS network and the H.323 network. It is assumed herein for example, that an originating terminal uses a standard codec provided in the H.323 network. When the originating terminal uses the standard codec provided in the H.323 network, it should preferably transmit a message up to the terminating terminal in order to determine whether there is any difference in codec between the nodes. However, there is no difference in other call flows.

Returning to FIG. 2, in step 201, the originating terminal 200 transmits an Invite message to the S-CSCF 210. The S-CSCF 210 receiving the Invite message checks in step 202 a subscriber type of the terminating terminal through a query to the DNS 250 for the subscriber that does not satisfy the following three conditions, which comprise a first condition that is to identify a subscriber through translation of a telephone office number when a terminating number is a Uniformed Resource Identifier (Tel Uri), a second condition that is to determine whether a corresponding subscriber is a self network's subscriber or another network's subscriber through HSS query, and a third condition that is to determine a subscriber type by sending a query to an I-CSCF, if the home network of the terminating subscriber is different from the home network of the originating subscriber.

If it is determined through step 202 that the terminating terminal 201 is an H.323 terminal, the S-CSCF 210 transmits an Invite message to the H.323-IWF 220 for interworking with the H.323 network in step 203. In this case, the Invite message comprises codec information of the originating terminal. If the H.323-IWF 220 determines from the codec information of the originating terminal included in the Invite message that the corresponding codec is not supportable in the H.323 network interworking therewith, it transmits a 606 Not Acceptable message to the S-CSCF 210. At this time, the codec list manager 222 of the H.323-IWF 220 transmits a codec list supportable in the H.323 network along with the 606 Not Acceptable message.

Upon receiving the 606 Not Acceptable message, the S-CSCF 210 transmits an Invite message to the AS 231 to request transcoding service in step 204, recognizing the need for transcoding. In step 205, the AS 231 transmits an Invite message to the MRF 233 to request the transcoding function. In response, the MRF 233 delivers capability information for the codec provided by the MRF to the AS 231 through a 200 OK message. Thereafter, in step 206, the AS 231 transmits an Invite message comprising the capability information for the codec provided by the MRF to the H.323-IWF 220 via the S-CSCF 210. In step 207, the H.323-IWF 220 transmits an Invite message to the H.323 gatekeeper 260. At substantially the same time, the message translator 221 of the H.323-IWF 220 translates the Invite message into a Call Setup message before transmission, and the RAS 223 executes a RAS command for the interworking with the gatekeeper. Then, in step 208, the H.323 gatekeeper 260 transmits a Call Setup message to the terminating terminal 201 located in the H.323 network. In step 209, the terminating terminal 201 transmits an Alerting message to the H.323 gatekeeper 260 to indicate the current ringing state. Subsequently, in step 210, the H.323 gatekeeper 260 forwards the Alerting message to the H.323-IWF 220.

In step 211, the H.323-IWF 220 transmits a 183 Session Progress message to the S-CSCF 210. The message translator 221 of the H.323-IWF 220 translates the Alerting message into a 183 Session Progress message and transmits the 183 Session Progress message to the S-CSCF 210. In step 212, the S-CSCF 210 forwards the 183 Session Progress message to the AS 231. The AS 231 handles bearer connection between the terminating terminal 201 and the MRF 233 using a PrAck message. The S-CSCF 210 finally transmits a 200 OK message to the originating terminal 200 in step 213. Upon receiving a 180 Ringing message and a Connect message (200 OK message) from the terminating terminal 201, the originating terminal 200 generates ACK to the S-CSCF 210, completing the call setup.

An exemplary call release process is not shown in the drawings. However, an exemplary process can comprise a BYE (REL) message and a 200 OK message that are exchanged among the originating terminal, the S-CSCF, the AS, the MRF, the H.323-IWF, the H.323 GK, and the terminating terminal, all of which were involved in the call setup, such that the call release is carried out.

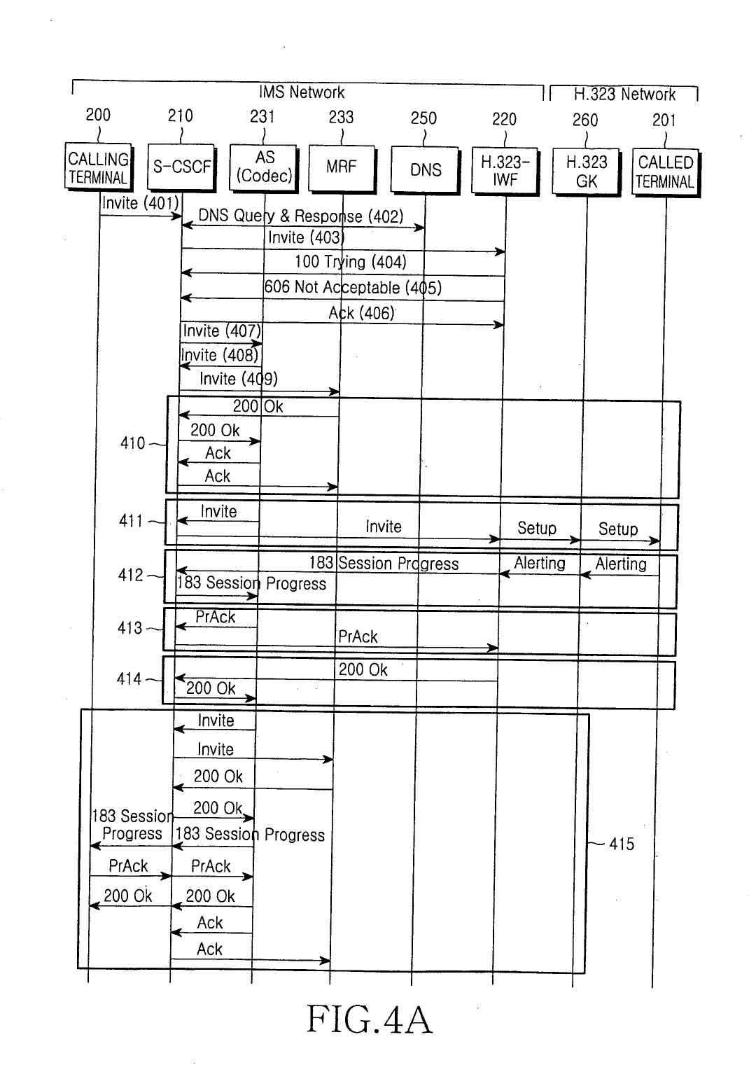

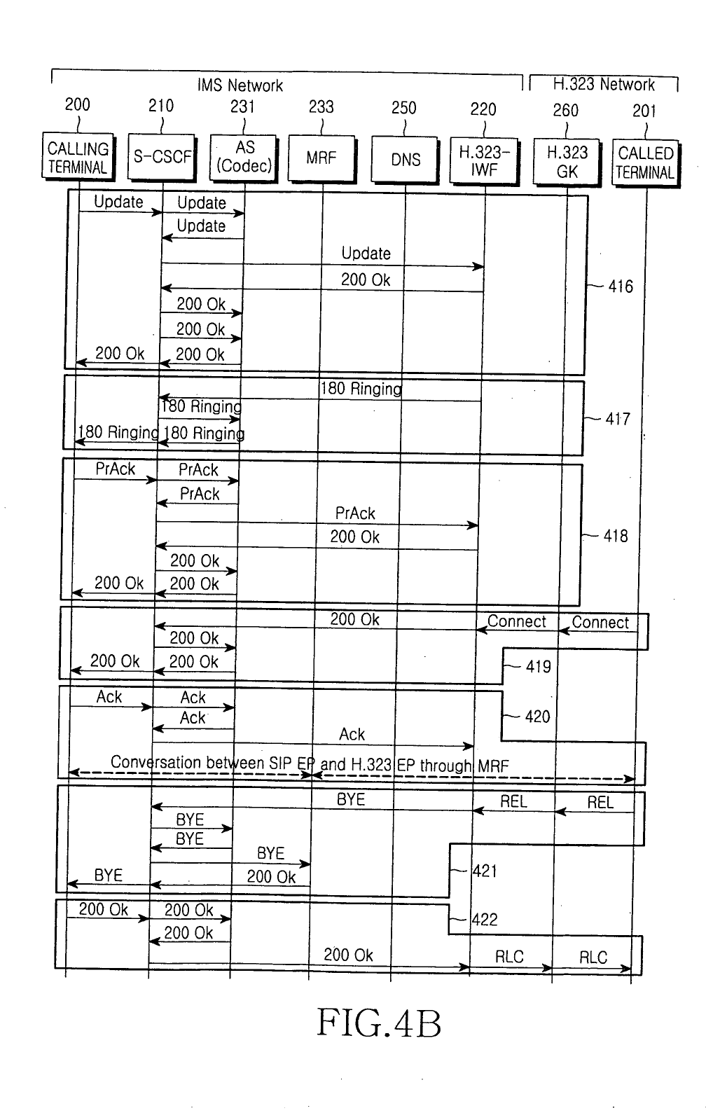

FIGS. 4A and 4B are signaling diagrams illustrating an exemplary interworking method between an IMS network and an H.323 network. With reference to FIGS. 4A and 4B, a description will now be made of an exemplary interworking method between an IMS network and an H.323 network according to an embodiment of the present invention. Herein, it is assumed for example, that an originating terminal is an IMS terminal and a terminating terminal is an H.323 terminal.

In step 401 of FIG. 4A, the originating terminal 200 transmits an Invite message to the S-CSCF 210. In step 402, the S-CSCF 210, if it does not satisfy the following 3 conditions, determines that corresponding interworking is interworking with the H.323 network, through a query to the DNS 250. As noted above, the three conditions comprise a first condition that is to identify a subscriber through translation of a telephone office number if a terminating number is a Tel Uri, a second condition that is to identify a self network's subscriber (IMS network subscriber) through a query to the HSS, and a third condition that is to determine a subscriber type by sending a query to an I-CSCF if a home network of the terminating subscriber is different from a home network of the originating subscriber.

In step 403, the S-CSCF 210 transmits an Invite message to the H.323-IWF 220. In step 404, the H.323-IWF 220 transmits a 100 Trying message to the S-CSCF 210. If the originating terminal 200 does not support an H.323 codec, the H.323-IWF 220 transmits a 606 Not Acceptable message to the S-CSCF 210 in step 405. In step 406, the S-CSCF 210 transmits an ACK message to the H.323-IWF 220 in response to the Invite message.

Thereafter, in step 407, the S-CSCF 210 transmits an Invite message to the AS 231 scheduled to perform transcoding. In steps 408 and 409, the AS 231 transmits an Invite message to an MRF 233 via the S-CSCF 210 to request execution of a transcoding function. If the AS 231 and the MRF 233 are combined into a single component, step 408 can be omitted.

In step 410, the MRF 233 transmits a 200 OK message to the AS 231 via the S-CSCF 210 to deliver capability information for its supportable codec. In response, the AS 231 transmits an ACK message to the MRF 233 via the S-CSCF 210. Thereafter, in step 411, the AS 231 transmits an Invite message for requesting call setup, to the H.323-IWF 220 via the S-CSCF 210. Further, the message translator 221 of the H.323-IWF 220 translates the Invite message into a Call Setup message, and transmits the Call Setup message to the H.323 gatekeeper 260. In this case, the RAS 223 executes a RAS command because corresponding interworking is interworking with the H.323 gatekeeper 260. Then, registration, connection authentication, bandwidth change, state report, and connection release procedures are performed between the H.323-IWF 220 and the H.323 gatekeeper 260. The H.323 gatekeeper 260 forwards the received Call Setup message to a terminating terminal 201.

In step 412, the terminating terminal 201 transmits an Alerting message to the H.323 gatekeeper 260 to indicate the current ringing state. The H.323 gatekeeper 260 forwards the Alerting message to the H.323-IWF 220. Then the message translator 221 of the H.323-IWF 220 translates the Alerting message into a 183 Session Progress message and transmits the 183 Session Progress message to the AS 231 via the C-CSCF 210.

Thereafter, in step 413, the AS 231 transmits a PrAck message to the H.323-IWF 220 via the S-CSCF 210. Then a bearer between the originating terminal 200 and the MRF 233 is connected through the PrAck message. In step 414, the H.323-IWF 220 transmits a 200 OK message to the AS 231 via the S-CSCF 210. Then a bearer between the terminating terminal 201 and the MRF 233 is connected through the 200 OK message.

In step 415, a Real-time Transport Protocol (RTP) connection between the originating terminal 200 and the MRF 233 is achieved. In step 416 of FIG. 4B, the originating terminal 200 transmits an Update message to the H.323-IWF 220 to finally check codec setting information. In step 417, the H.323-IWF 220 transmits a 180 Ringing message to send a ring to the originating terminal 200. In step 418, in response to the 180 Ringing message, the originating terminal 200 transmits a PrAck message and receives a 200 OK message.

In step 419, if a user of the terminating terminal 201 answers the call (or pushes a Call button), a Connect message indicating setup of the call is transmitted to the H.323-IWF 220 via the H.323 gatekeeper 260, and the H.323-IWF 220 transmits a 200 OK message to the originating terminal 200. In step 420, if the originating terminal 200 transmits an ACK message to the H.323-IWF 220, conversation with the terminating terminal 201 via the MRF 233 is started.

If the user of the terminating terminal 201 ends the call (or pushes an End button), a BYE (REL) message is transmitted to the originating party in step 421. In step 422, the originating terminal 200 transmits a 200 OK message to the H.323-IWF 220 in response to the BYE message.

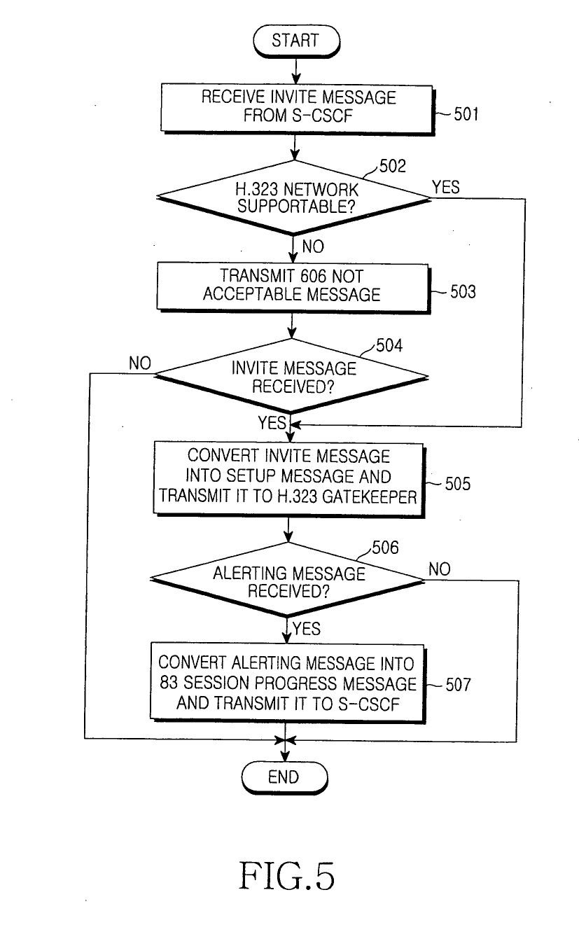

FIG. 5 is a flowchart illustrating an exemplary control flow of an H.323-IWF during interworking between an IMS network and an H.323 network according to an embodiment of the present invention.

In the control flow of FIG. 5, the H.323-IWF 220 receives an Invite message from an S-CSCF 210 in step 501, and determines in step 502 whether a codec acceptable by an originating terminal 200 is supportable in an H.323 network with which it can interwork. If the codec acceptable by the originating terminal 200 is supportable in the H.323 network, the H.323-IWF 220 performs interworking with the H.323 network in step 505. However, if the codec acceptable by the originating terminal 200 is not supportable in the H.323 network, the H.323-IWF 220 transmits a 606 Not Acceptable message to the S-CSCF 210 in step 503. The 606 Not Acceptable message comprises a codec list provided by a codec list manager 222. The codec list denotes a list of codecs supported in the H.323 network that interworks with the IMS network.

In step 504, the H.323-IWF 220 determines whether there is any Invite message comprising codec information provided by the MRF 233, received from the S-CSCF 210. Upon failure to receive the Invite message, the H.323-IWF 220 ends the flow. However, upon receiving the Invite message, the H.323-IWF 220 translates the Invite message into a Call Setup message and transmits the Call Setup message to an H.323 gatekeeper 260 in step 505. Thereafter, the H.323-IWF 220 determines in step 506 whether there is any Alerting message indicating the current ringing state, received from the H.323 gatekeeper 260. Upon failure to receive the Alerting message, the H.323-IWF 220 ends the flow. However, upon receiving the Alerting message, the H.323-IWF 220 translates the Alerting message into a 183 Session Progress message and transmits the 183 Session Progress message to the S-CSCF 210 in step 507.

As can be understood from the foregoing description, embodiments of the present invention can provide a signaling translation function between an IMS network and an H.323 network. Embodiments of the present invention can also provide a transcoding function between the IMS network and the H.323 network.

In addition, embodiments of the present invention can detect an inconsistency between a codec used by an originating terminal and a codec used by a terminating terminal.

Further, embodiments of the present invention can simplify the Call Flow necessary for codec negotiation between an originating terminal and a terminating terminal.

Moreover, H.323-IWF, AS, and MRF, which are function blocks defined for interworking between an IMS network and an H.323 network, are collectively implemented in one network element, or separately implemented in a plurality of network elements.

While the invention has been shown and described with reference to a certain exemplary embodiments thereof, it will be understood by those skilled in the art that various changes in form and details may be made therein without departing from the spirit and scope of the invention as defined by the appended claims.

What is claimed is:

1. A system for interworking between an Internet Protocol (IP) Multimedia Core Network Subsystem (IMS) network that provides an IP multimedia service to at least one first terminal, and an H.323 network that provides a packet switched multimedia service to at least one second terminal, the system comprising:
a Call Session Control Function (CSCF) for, upon receiving an invite message from the first terminal, transmitting an invite message comprising codec information of the first terminal to an interworking function (IWF) if the second terminal is determined to be a terminal serviceable via the H.323 network through a query with a Domain Name Server (DNS) that provides subscriber information, and sending a request for a transcoding service to a transcoding unit upon receiving from the IWF a response message comprising a codec list supportable in the H.323 network;
the IWF for, upon receiving an invite message comprising codec information of the first terminal from the CSCF, transmitting to the CSCF a codec list supportable in the H.323 network with which it can interwork, and upon receiving from the CSCF an invite message comprising codec information provided by the transcoding unit, translating the received invite message into a call setup message and transmitting the call setup message to the H.323 network; and
a gatekeeper for setting up a call to the IMS network upon receiving the call setup message from the CSCF.

2. The system of claim 1, further comprising a Domain Name Server (DNS) for providing subscriber information of the second terminal.

3. The system of claim 1, further comprising a transcoding unit for providing a transcoding service upon receiving the invite message comprising the codec list from the CSCF.

4. The system of claim 3, wherein the transcoding unit comprises:
an application server (AS) for requesting transcoding upon receiving the invite message comprising the codec list from the CSCF; and
a Multimedia Resource Function (MRF) for, upon receiving a transcoding request from the AS, transcoding different codecs of the first terminal and the second terminal, and transmitting transcoding information to the AS.

5. The system of claim 1, wherein upon receiving from the H.323 network an alerting message indicating a current ringing state, the IWF is configured to translate the alerting message into a 183 Session Progress message and transmit the 183 Session Progress message to the CSCF.

6. The system of claim 1, wherein upon receiving the call setup message from the CSCF, the gatekeeper is configured to forward the call setup message to the second terminal, and upon receiving an alerting message indicating a current ringing state from the second terminal, forward the alerting message to the CSCF.

7. The system of claim 1, wherein the IWF comprises:
a message translator for translating a message transmitted between the IMS network and the H.323 network;
a codec list manager for providing a codec list supportable by the H.323 network to the CSCF for a first invite message in the IMS network;
a Registration, Admission, and Status (RAS) for executing a RAS command through a RAS signal processing protocol for interworking with the H.323 network; and
a controller for controlling interworking between the IMS network and the H.323 network.

8. The system of claim 1, wherein the response message comprises a 606 Not Acceptable message indicating unacceptability of the codec information of the first terminal.

9. A method for interworking between an Internet Protocol (IP) Multimedia Core Network Subsystem (IMS) network that provides an IP multimedia service to at least one first terminal, and an H.323 network that provides a packet switched multimedia service to at least one second terminal, the method comprising the steps of:
upon receiving an invite message from the first terminal, determining by a Call Session Control Function (CSCF) whether the second terminal is a terminal serviceable via the H.323 network through a query with a Domain Name Server (DNS);
if the second terminal is a terminal serviceable via the H.323 network, transmitting, by the CSCF, an invite message comprising codec information of the first terminal to an interworking function (IWF), and sending a request for a transcoding service to a transcoding unit upon receiving from the IWF a response message comprising a codec list supportable by the H.323 network;
upon receiving an invite message comprising transcoding information from the transcoding unit via the CSCF, translating, by the IWF, the invite message into a call setup message and transmitting the call setup message to the H.323 network; and
upon receiving the call setup message from the IWF, setting up, by a gatekeeper, a call to the IMS network.

10. The method of claim 9, wherein the step of sending a request for a transcoding service further comprises the step of:
providing the transcoding service by the transcoding unit upon receiving an invite message comprising the codec list from the CSCF.

11. The method of claim 10, wherein the step of providing the transcoding service comprises the steps of:
upon receiving an invite message comprising the codec list from the CSCF, sending, by an application server (AS), a request for transcoding to a Multimedia Resource Function (MRF); and
upon receiving the transcoding request from the AS, transcoding, by the MRF, different codecs of the first terminal and the second terminal and transmitting transcoding information to the AS.

12. The method of claim 9, wherein after the step of setting up a call to the IMS network, further comprising the step of:
upon receiving an alerting message indicating a current ringing state from the H.323 network, translating, by the IWF, the alerting message into a 183 Session Progress message and transmitting the 183 Session Progress message to the CSCF.

13. The method of claim 9, wherein the step of setting up a call to the IMS network comprises the steps of:
upon receiving the call setup message from the IWF, forwarding by the gatekeeper the call setup message to the second terminal; and
upon receiving an alerting message indicating a current ringing state from the second terminal, forwarding by the gatekeeper the alerting message to the IWF.

14. The method of claim 9, wherein the response message comprises a 606 Not Acceptable message indicating unacceptability of the codec information of the first terminal.

15. An apparatus for interworking between an Internet Protocol (IP) Multimedia Core Network Subsystem (IMS) network that provides an IP multimedia service to at least one first terminal, and an H.323 network that provides a packet switched multimedia service to at least one second terminal, the apparatus comprising:
a message translator for translating a message transmitted between the IMS network and the H.323 network;
a codec list manager for providing a codec list supportable by the H.323 network to a Call Session Control Function (CSCF) through a response message, for a first invite message in the IMS network;
a Registration, Admission, and Status (RAS) for executing a RAS command through a RAS signal processing protocol for interworking with a gatekeeper; and
a controller for controlling interworking between the IMS network and the H.323 network.

16. The apparatus of claim 15, wherein the response message comprises a 606 Not Acceptable message indicating unacceptability of the codec information of the first terminal.

17. The apparatus of claim 15, wherein upon receiving an invite message comprising transcoding information from the transcoding unit via the CSCF, the message translator is configured to translate the invite message into a call setup message and transmit the call setup message to the H.323 network.

18. The apparatus of claim 15, wherein upon receiving an alerting message indicating a current ringing state from the H.323 network, the message translator is configured to translate the alerting message into a 183 Session Progress message and transmit the 183 Session Progress message to the CSCF.

19. A method for interworking between an Internet Protocol (IP) Multimedia Core Network Subsystem (IMS) network that provides an IP multimedia service to at least one first terminal, and an H.323 network that provides a packet switched multimedia service to at least one second terminal, the method comprising the steps of:
receiving an invite message comprising codec information of the first terminal from a Call Session Control Function (CSCF);
determining whether a codec of the first terminal is supportable in the H.323 network;
if the codec of the first terminal is unsupportable, transmitting a response message to the CSCF;
determining whether there is any invite message comprising transcoding information, received from a transcoding unit; and
upon receiving an invite message comprising the transcoding information, translating the invite message into a call setup message and transmitting the call setup message to the H.323 network.

20. The method of claim 19, further comprising the steps of:
determining whether there is any alerting message indicating a current ringing state, received from the H.323 network; and
upon receiving the alerting message, translating the alerting message into a 183 Session Progress message.

21. The method of claim 19, wherein the response message comprises a 606 Not Acceptable message indicating unacceptability of the codec information of the first terminal.
